(19) United States
(12) Patent Application Publication
(10) Pub. No.: US 2016/0222838 A1
(43) Pub. Date: Aug. 4, 2016

(54) Spherical rotary valve having bifurcated apertures

(71) Applicant: George J. Coates, Wall Twp, NJ (US)

(72) Inventor: George J. Coates, Wall Twp, NJ (US)

(21) Appl. No.: 14/544,642

(22) Filed: Jan. 29, 2015

(51) Int. Cl. F01L 7/10; F16K 27/04

(52) U.S. Cl. CPC F01L 7/10; F16K 27/04

(57) ABSTRACT

An improved rotary valve for a spherical rotary valve engine in which the intake spherical valve and the exhaust spherical valve have an aperture on the spherical periphery for communication with the inlet port and exhaust port of the cylinder, respectively, the aperture having longitudinal parallel edges spaced apart a distance equivalent to the diameter of the inlet port or the exhaust port of the cylinder head, the lateral ends of the aperture on the spherical periphery of the intake and exhaust valve being curvilinear and of a semi-circular design, the apertures being bifurcated by a rib member extending between the curvilinear semi-circular lateral end walls of the aperture, the rib members upper surface conforming to the spherical peripheral arcuate shape of the rotary valve.

### BACKGROUND OF THE INVENTION

1. Field of the Invention

The present invention relates to internal combustion engines utilizing spherical rotary valve assemblies, and in particular, to an improved rotary valve having a bifurcated aperture on the spherical periphery for communication with the inlet port and the exhaust port of the cylinder respectively, the aperture having longitudinal parallel edges spaced apart a distance equivalent to the diameter of the inlet port or the exhaust port of the cylinder head, the lateral ends of the aperture being curvilinear and of a semi-circular design, the aperture being bifurcated by a support rib between the curvilinear semi-circular ends of the aperture, the support rib matching the spherical periphery of the valve.

2. Description of the Prior Art

The Applicant herein has directed considerable attention to the internal combustion engine of the piston-cylinder type and in particular to the replacement of the poppet valve system, including the poppet valve, springs, mountings and associated cam shaft, with a spherical rotary valve assembly for the introduction of the fuel air mixture into the cylinder and for the evacuation of the exhaust gases. Applicant is the named inventor in U.S. Pat. No. 4,989,576, “Internal Combustion Engine”; U.S. Pat. No. 4,944,261, “Spherical Rotary Valve Assembly for Internal Combustion Engine”; U.S. Pat. No. 4,953,527, “Spherical Rotary Valve Assembly for Internal Combustion Engine”; U.S. Pat. No. 4,976,232, “Valve Seal for Rotary Valve Engine”; U.S. Pat. No. 4,989,558, “Spherical Rotary Valve Assembly for Internal Combustion Engine”; U.S. Pat. No. 5,109,814, “Spherical Rotary Valve”; U.S. Pat. No. 5,361,739, “Spherical Rotary Valve Assembly for Use in a Rotary Valve Internal Combustion Engine”; and U.S. Pat. No. 6,308,676 B1, “Cooling System for Rotary Valve Engine”. The aforementioned U.S. patents are incorporated herein as if set forth in length and in detail.

The present invention relates to an improved spherical rotary valve, and in particular deals with the aperture in the spherical periphery of the valve, which comes into successive alignment with the inlet port and the exhaust port respectively.

Applicant has adapted the spherical rotary valve assembly to high compression diesel engines which operate on natural gas and which in many instances operate on natural gas directly from the well head. Due to the high compression of the engine and the combustion of unrefined natural gas, significant force is affected against the valve seal and this force is transmitted to the spherical rotary valve which in rotation contacts the upper spherical complimentary surface of the valve seal, forming the seal. This additional force generated from the high compression and combustion of natural gas produces excessive friction and wear which is not required in order to form the seal between the spherical rotary valve and the valve seal. It was necessary to somehow eliminate this additional force and/or pressure or to equalize it in some manner such that it does not affect the rotation of the spherical rotary valve and its sealing contact with the upper surface of the valve seal.

Applicant's Pressure Equalizing Valve Seal for Spherical Rotary Valve Engine, U.S. Pat. No. 7,647,909, addressed the aforesaid problem from the valve seal perspective. However, due to the force generated from the high compression, it was determined that when the apertures on the spherical periphery of the intake and exhaust valves, such apertures detailed in Applicant's U.S. Pat. No. 5,109,814 entitled “Spherical Rotary Valve”, approached alignment with the inlet or exhaust port, a rocking motion with respect to the seal was affected. Applicant has solved this problem by bifurcating the aperture on the spherical periphery with a rib member conforming to the arcuate spherical periphery and eliminating the rocking motion of the valve seal.

### OBJECTS OF THE INVENTION

An object of the present invention is to provide for a novel and improved spherical rotary valve for use in a rotary valve engine.

A further object of the present invention is to provide for a novel and improved spherical rotary valve in which the aperture on the spherical periphery alignable with an inlet port or an exhaust port is bifurcated.

A still further object of the present invention is to provide for a novel and improved spherical rotary valve in which the bifurcation of the aperture on the spherical periphery is accomplished with a rib member which is complimentary with the spherical periphery.

A still further object of the present invention is to provide for a novel spherical rotary valve for use in a rotary valve engine in which the bifurcating rib member presents interaction between the periphery of the aperture in the spherical periphery of the valve and the underlying valve seal.

### SUMMARY OF THE INVENTION

An improved rotary valve for a spherical rotary valve engine in which the intake spherical valve and the exhaust spherical valve have an aperture on the spherical periphery for communication with the inlet port and exhaust port of the cylinder, respectively, the aperture having longitudinal parallel edges spaced apart a distance equivalent to the diameter of the inlet port or the exhaust port of the cylinder head, the lateral ends of the aperture on the spherical periphery of the intake and exhaust valve being curvilinear and of a semi-circular design, the apertures being bifurcated by a support rib member extending between said curvilinear semi-circular lateral end walls of said aperture, the rib members' upper surface conforming to the spherical peripheral arcuate shape of the rotary valve.

### BRIEF DESCRIPTION OF THE DRAWINGS

These and other advantages and improvements will be evident, especially when taken in light of the following illustrations wherein:

FIG. 1 is a side elevational view of an intake spherical rotary valve having a single port for use on an internal combustion engine when the valve mechanism operates at one-half the speed of the crankshaft;

FIG. 2 is an end elevational view of an intake spherical rotary valve as illustrated in FIG. 1;

FIG. 3 is a side elevational view of an exhaust spherical rotary valve for use in an internal combustion engine in which the valve mechanism operates at one-half the speed of the crankshaft;

FIG. 4 is an end elevational view of an exhaust spherical rotary valve as illustrated in FIG. 5;

FIG. 5 is a side cross-sectional view of the intake spherical rotary valve mounted in a cylinder head.

### DETAILED DESCRIPTION OF THE INVENTION

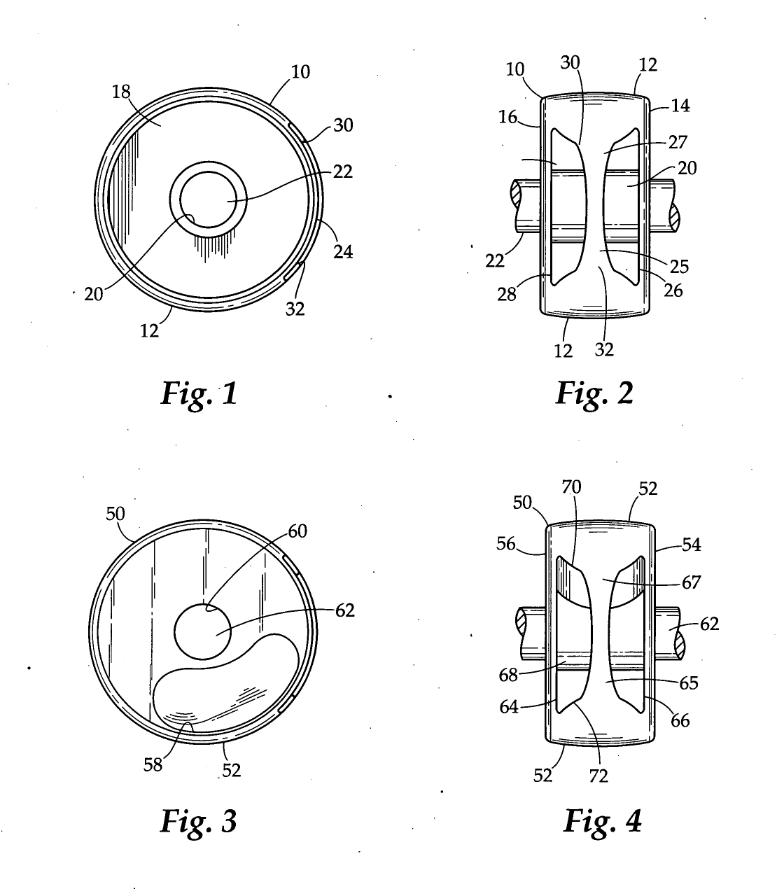

FIGS. 1 and 2 illustrate a side elevational view and an end elevational view of an intake spherical rotary valve drum 10 for use in a spherical rotary valve internal combustion engine. Intake spherical rotary valve drum 10 is defined by an arcuate spherical circumferential periphery 12 and planar opposing side walls 14 and 16 thereby presenting a spherical section. Centrally disposed inwardly from planar side wall 16 is an annular U-shaped donut cavity 18 which extends from planar side wall 16 to a depth approximate to planar side wall 14, the corners and edges of U-shaped cavity 18 are preferably machined such that they are rounded.

There is centrally disposed through intake spherical rotary drum 10 a central aperture 20 extending from planar side wall 16 through planar side wall 14, aperture 20 being centrally disposed through intake spherical rotary drum 10 so as to provide a means for mounting intake spherical rotary drum 10 on a centrally-disposed shaft 22 to provide for rotational disposition of intake spherical rotary drum 10 as further described hereafter.

Passing through arcuate spherical circumferential periphery 12 and providing communication with annular U-shaped or donut cavity 18 is an intake aperture 24. Intake aperture 24 is elongated having parallel disposed side walls 26 and 28 and opposing arcuate end walls 30 and 32. Arcuate end walls 30 and 32 are defined by the arc of a circle, the radius of arcuate end walls 30 and 32 being substantially equal to the radius of the inlet port to cylinder as discussed hereafter.

The intake spherical rotary valve drum 10 as illustrated in FIGS. 1 and 2 contains one aperture 24 in its periphery, communicating with U-shaped donut cavity 18. This configuration is utilized in internal combustion engines in which the valve mechanism of the engine rotates in one half the speed of the crankshaft. Therefore, the aperture 24 in the spherical circumferential periphery of intake spherical rotary valve drum 10 will come into communication with the inlet port of the cylinder once every revolution of intake spherical rotary valve drum 10. It will be recognized by those of ordinary skill in the art that an intake spherical rotary valve drum 10 designed to rotate at one quarter the speed of the engine crankshaft would require a second, opposing aperture 24 (not shown).

Referring to FIGS. 3 and 4, there is illustrated an end elevational view and a side elevational view of an exhaust spherical rotary valve drum 50. Exhaust spherical rotary valve drum 50 is defined by an arcuate spherical circumferential periphery 52 and planar opposing side walls 54 and 56, thereby presenting a spherical section identical to the spherical section of the intake spherical rotary valve drum 10. Disposed on a planar side wall 56 is an aperture 58 which in the embodiment disclosed in FIG. 3 is kidney-shaped.

There is centrally disposed through exhaust spherical rotary valve drum 50 the central aperture 60 extending from planar side wall 56 through planar side wall 54, aperture 60 being centrally disposed through exhaust spherical rotary drum 50 so as to provide a means for mounting exhaust spherical rotary drum 50 on a centrally disposed shaft 62 to provide for the rotational disposition of exhaust spherical rotary drum 50 as further described hereafter.

Passing through arcuate spherical circumferential periphery 52 and providing communication with kidney-shaped opening 58 is an exhaust aperture 64. Exhaust aperture 64 is elongated having parallel disposed side walls 66 and 68 and opposing arcuate end walls 70 and 72. Arcuate end walls 70 and 72 are defined by the arc of the circle, the radius of the arcuate end walls 70 and 72 being substantially equal to the radius of the exhaust port of the cylinder as discussed hereafter.

The exhaust spherical rotary valve drum 50 as illustrated in FIGS. 3 and 4 contains one aperture 64 in its spherical periphery 52 communicating with one kidney-shaped opening 58 in side wall 56. This configuration is utilized in internal combustion engines in which the valve mechanism of the engine rotates at one half the speed of the crankshaft. Therefore, the aperture 64 on spherical circumferential periphery of exhaust rotary valve drum 50 will come into communication with the exhaust port of the cylinder once every revolution of the exhaust spherical rotary valve drum 50. It will be recognized by those of ordinary skill in the art that an exhaust spherical rotary valve drum designed to rotate at one quarter the speed of the engine crankshaft would require a second opposing aperture 64 on the spherical periphery 52 of exhaust spherical rotary valve drum 50, said second aperture being in communication with a second kidney-shaped opening 58.

The shape of apertures 24 and 64 on the intake spherical rotary valve drum 10 and the exhaust spherical rotary valve drum 50 are designed to permit the early opening of the inlet port exhaust port and the delayed closing of the inlet port and the exhaust port for optimum engine function. The design performs as desired with respect to normal internal combustion engines. However, when graduating to higher compression engines, such as diesels or the like, and in particularly, higher compression engines which are operating on exotic fuels, a certain wobble, vibration, or rocking motion is introduced into the valve seal upon which the spherical rotary valve drum rotates as apertures 24 and 64 align with the inlet port. This problem is addressed by an additional structural element introduced into the intake spherical rotary valve drum 10 and the exhaust spherical rotary valve drum 50. It consists of a bifurcating rib 25 and 65 respectively which bifurcates apertures 24 and 64 and which extends between the arcuate end walls 30 and 32 of intake spherical rotary valve drum 10 and the arcuate end walls 70 and 72 of the exhaust spherical rotary valve drum 50. Bifurcating ribs 25 and 65 have the same spherical circumferential peripheral outer surface 27 and 67 as the arcuate spherical circumferential periphery of the intake spherical rotary valve drum 10 or the exhaust spherical rotary valve drum 50.

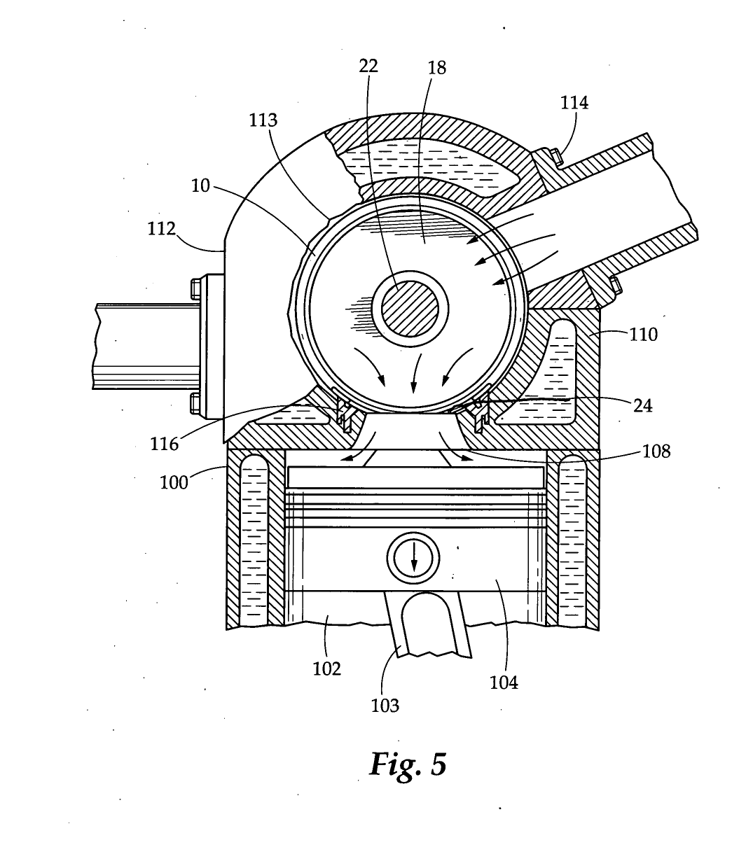

FIG. 5 illustrates a side cross-sectional view of an intake spherical rotary valve drum 10 positioned in an engine block 100 having disposed therein a cylinder cavity 102, there being positioned within cylinder cavity 102 a reciprocating piston 104 secured to a crankshaft arm 103 which reciprocates within cylinder cavity 102. Applicant's intake spherical rotary valve drum 10 is secured within a split head comprising a first lower section 110 which is secured to engine block 100, and which has position therein an intake port 108 in communication with cylinder cavity 102. The upper portion 112 of the split head when secured to the lower portion 110 defines a drum accommodating cavity 113 for intake spherical rotary valve drum 10. When upper half 112 and lower half 110 of the split head are secured to the engine block, intake spherical rotary valve drum 10 is rotationally encapsulated within the cavity defined by the two halves of the split head assembly.

U-shaped or donut cavity 18 on the intake spherical rotary valve drum 10 is continuously charged with a fuel/air mixture through inlet port 114 and this fuel/air mixture is introduced into cylinder cavity 102 through inlet port 108 when the intake aperture 24 comes into rotational alignment with the inlet port 108. A sealing mechanism in the form of a valve seal 116 is positioned about inlet port 108 and cooperates with the arcuate circumferential periphery 12 of the intake spherical rotary valve drum 10 to provide an effective gas tight seal. The upper surface of the valve seal 116 is arcuate and cooperative with the spherical periphery of the intake spherical rotary valve drum 10 in that it is the only surface within the drum accommodating cavity 113 which is in contact with the intake spherical rotary valve drum 10. The contact between valve seal 116 and the spherical periphery of intake spherical rotary valve drum 10 occurs across the entire periphery from side wall 14 to side wall 16 during the intake spherical rotary valve drum 10's rotation. When the aperture 24 on the spherical periphery of intake spherical rotary valve drum 10 commences rotational alignment with inlet port 108, the surface contact is limited to the spherical circumferential periphery between side walls 14 and 16 respectively and elongated parallel disposed side walls 26 and 28 of intake aperture 24.

Bifurcating rib 25 with respect to intake aperture 24 provides an additional extended contact surface which spans the length of intake aperture 24 during rotation of intake spherical rotary valve drum 10. Spanning the length of intake aperture 24 between arcuate end walls 30 and 32 provides additional surface contact during the rotation of the intake spherical rotary valve drum 10, particularly when aperture 24 commences alignment with the inlet port and through the closure of the inlet port. This is particularly useful in high compression engines wherein the valve seal 116 under high pressure may have a tendency to wobble or rock and introduce a clicking sound evidencing an unwanted frictional contact indicative of potential contact wear problems. The bifurcated rib addresses and solves this problem by spanning the inlet port opening in valve seal 116 as the rotary valve comes into registration with it.

The engine block and the relationship between the intake spherical rotary valve drum 10 and valve seal 116 has been described. The same description is applicable to the exhaust spherical rotary valve drum 50 and a more detailed explanation with respect to the exhaust spherical rotary valve drum 50 can be found in Applicant's prior incorporated patents.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. An improved spherical rotary intake valve for use in a rotary valve internal combustion engine for cooperation with the inlet port of a cylinder of said internal combustion engine for the introduction of a fuel/air mixture into said cylinder, said improved spherical rotary valve having a drum body of spherical section formed by two parallel planar side walls of a sphere disposed about a center thereof, thereby defining a spherical shaped peripheral end wall and formed with a shaft receiving aperture between said planar side walls, said drum body formed with a donut-shaped cavity in one said side wall thereof and at least one aperture formed in said spherical peripheral shaped end wall in communication with said donut-shaped cavity, said aperture formed in said spherical peripheral shaped end wall having longitudinally disposed side walls substantially parallel to said planar side walls of said drum body, said end walls of said aperture formed with a spherical shaped end wall comprised of opposing curvilinear semi-circular shapes, the radius thereof equaling the radius of an inlet port of said cylinder, said improvement comprising:
a bifurcating rib extending between said opposing curvilinear semi-circular shaped end walls, said bifurcating rib contacting a valve seal surrounding said inlet port of said cylinder during rotation of said spherical rotary intake valve.

2. The improved spherical rotary intake valve as defined in claim 1 wherein said donut-shaped cavity is U-shaped in cross-section.

3. The improved spherical rotary intake valve as defined in claim 1 wherein said parallel side walls of said aperture in said spherical periphery shaped end wall are spaced apart a distance equal to a diameter of said inlet port.

4. The improved spherical rotary intake valve as defined in claim 1 wherein a plurality of apertures are disposed on spherical shaped end wall, each of said apertures having said bifurcating rib member.

5. An improved rotary exhaust valve for use in a rotary valve internal combustion engine for cooperation with an exhaust port of a cylinder of said internal combustion engine for evacuation of spent gases from said cylinder, said improved rotary exhaust valve having a drum body of spherical section formed from by two parallel planar side walls of a sphere disposed about a center of said sphere thereby defining a spherical shaped peripheral end wall and formed with a shaft receiving aperture between said planar side walls, said drum body formed with a conduit extending between an aperture in said spherically shaped end wall to an aperture in one of said planar side walls, said aperture in said spherical shaped end wall having longitudinally disposed side walls substantially parallel to said planar side walls of said drum body, said end walls of said aperture formed in said spherically shaped end wall comprised of opposed, curvilinear, semi-circular shapes, the radius thereof equaling the radius of an outlet port of said cylinder, said improvement comprising;
a bifurcating rib extending between said opposing curvilinear semi-circular shaped end walls, said bifurcating rib contacting a valve seal surrounding said inlet port of said cylinder during rotation of said spherical rotary intake valve.

6. The improved rotary exhaust valve as defined in claim 5 wherein said parallel side walls of said aperture in said spherically shaped end wall are spaced apart a distance equal to the diameter of said outlet port.

7. The improved rotary exhaust valve as defined in claim 5 wherein a plurality of said apertures are disposed on said spherical shaped end wall, each having said bifurcated rib member, each of said apertures in communication with a corresponding aperture in one of said planar side walls.
